(19) United States
(12) Patent Application Publication
(10) Pub. No.: US 2018/0047012 A1
(43) Pub. Date: Feb. 15, 2018

(54) METHOD FOR MOBILE PAYMENT BY SMART MULTICARD AND APPLICATION FOR SMART MULTICARD

(71) Applicant: BRILLIANTTS CO., LTD., Gyeonngi-do (KR)

(72) Inventor: Jae Hun BAE, Gyeonngi-do (KR)

(73) Assignee: BRILLIANTTS CO., LTD., Gyeonggi-do (KR)

(21) Appl. No.: 15/528,209

(22) PCT Filed: Nov. 20, 2015
(86) PCT No.: PCT/KR2015/012568

§ 371 Date: May 19, 2017

(30) Foreign Application Priority Data
Nov. 20, 2014 (KR) 10-2014-0162789
Nov. 20, 2014 (KR) 10-2014-0162793
Nov. 20, 2015 (KR) 10-2015-0163402

(51) Int. Cl. G06Q 20/34; H04L 9/30; H04W 12/06; G06F 9/44

(52) U.S. Cl. CPC G06Q 20/34; G06F 9/44; H04L 9/30; H04W 12/06

(57) ABSTRACT

A mobile payment method using a smart multi card and a smart multi card application, enabling the automatic recommendation of a card to be used when making a mobile payment. The mobile payment method using a smart multi card, includes storing card information of a smart multi card; collecting order information on an ordered product through a user terminal; choosing a recommended card that is adequate considering the order information among a plurality of cards included in the smart multi card; and transmitting the card information of the recommended card to the smart multi card.

### FIELD OF THE INVENTION

The present invention relates to a mobile payment method using a smart multi card and an application for a smart multi card, and more particularly, to a mobile payment method using a smart multi card which automatically recommends a card to be used for a mobile payment, and an application for a smart multi card.

### RELATED ART

As modern society has rapidly become information-based and credit-based after industrialization, the use of credit cards has increased to be as much as that of cash. Accordingly, the number of credit cards carried by a regular adult has also significantly increased, and thus each person uses at least two or three cards, and in some cases, ten or more cards are held and used

Also, in accordance with marketing activation, issuance of various point cards has become an essential marketing item in most business to consumer (B2C)-based corporations and has generally been utilized to increase sales at small stores located in commercial areas. Thus, tens of cards are actually being unintentionally issued.

However, most of such cards are discarded after generation, which just leads to unnecessary issuing costs and social costs. Further, in some cases, point cards or discount cards of stores that are not frequently visited cannot be utilized when such cards are not held during actual visits. This causes avoidance of card issuance due to inconvenient and complex card management from a consumer standpoint and causes generation of unnecessary marketing costs from a corporate standpoint. That is, this causes waste and irrationality in terms of both supply and demand.

For credit cards, which are actually determined to have higher utilization than point cards, the number of credit cards held by each person increased to 4 in 2001, stopped increasing for a while after credit card liquidity crisis, and then continued to increase to 4.9 in 2011. The total number of credit cards that have been issued has reached about 122,130,000 in 2011.

While the number of cards issued has continuously increased, the number of cards that are actually used by each person is just 1.4. As a result, most credit cards held by each person are dormant, and about 20,000,000 or more cards (corresponding to about 40,000,000,000 won or more) are actually being discarded.

When various cash replacement cards such as debit cards, check cards, cash cards, and prepaid cards or marketing cards such as point cards or discount cards are included in the above figure, it is feasible to say that astronomical costs are being wasted.

Every time a user tries to make a payment while having such a number of cards, it is inconvenient for the user to manually find a card to be used for the payment among the cards that he or she owns. Also, when the user makes a mobile payment using a user terminal, such as a smart phone or the like, it is inconvenient for the user to select a card to be used from among numerous cards and manually input card information (e.g., a card security code, a card verification code, and a card verification value). Further, there is a risk that the card information will be exposed to other people during a process of inputting the card information into the user terminal.

### SUMMARY OF THE INVENTION

The present invention is directed to providing a mobile payment method using a smart multi card which automatically recommends a card to be used for a mobile payment when the payment is made using a smart multi card including a plurality of pieces of card information, and an application for a smart multi card.

To solve the problem described above, A mobile payment method using a smart multi card according to an embodiment of the present invention includes storing card information of a smart multi card, collecting order information of a product ordered through a user terminal, selecting a recommended card suitable for the order information from among a plurality of cards included in the smart multi card; and transmitting card information of the recommended card to the smart multi card.

Also, the selecting of the recommended card includes receiving event information related to the order information from a market server, receiving card application status information of the smart multi card from a financial institution server, selecting the recommended card based on at least one of a discount rate and a reward rate acquired from the event information and when a plurality of recommended cards are selected based on the at least one of the discount rate and the reward rate, selecting one of the plurality of recommended cards based on the card application status information.

Also, the selecting of the recommended card includes, when several pieces of order information are collected, selecting a recommended card for each of the pieces of order information.

Also, the mobile payment method further includes displaying an order information list including the several pieces of order information; and when a predetermined piece of order information is selected from the order information list, transmitting card information of a recommended card corresponding to the selected piece of order information to the smart multi card.

Also, the card information of the recommended card corresponding to the selected piece of order information is encrypted using a previously stored encryption key and then transmitted to the smart multi card, and the encryption key is received from a financial institution server which has issued the smart multi card.

Also, the mobile payment method further includes determining a wireless communication method for data transmission and reception with the smart multi card, receiving encrypted user authentication information from the smart multi card, performing user authentication based on the encrypted user authentication information and previously stored user authentication information, when the user authentication succeeds, requesting card information of a card to be used for a payment from the smart multi card, receiving encrypted card information of the recommended card from the smart multi card; and processing the payment based on the encrypted card information of the recommended card.

Also, wherein the determining of the wireless communication method includes when a first wireless communication method is in an active state, calculating a distance from the smart multi card based on a strength of a wireless signal received from the smart multi card, when the calculated distance is less than or equal to a reference distance, keeping the first wireless communication method in the active state, and when the calculated distance is greater than the reference distance, deactivating the first wireless communication method and activating a second wireless communication method.

Also, the performing of the user authentication includes decrypting the encrypted user authentication information using a previously stored decryption key, when the decrypted user authentication information coincides with the previously stored user authentication information, determining that the user authentication has succeeded and when the decryption fails or the decrypted user authentication information does not coincide with the previously stored user authentication information, determining that the user authentication has failed, and the decryption key is received from a financial institution server.

Also, the recommended card information is loaded onto the smart multi card.

When a user tries to make an offline mobile payment or an online mobile payment using a smart multi card in which card information of a plurality of cards is stored, convenience of the user is improved by automatically recommending and loading a card suitable for the payment onto the smart multi card.

When a user tries to make an online mobile payment using a smart multi card, a wireless communication method between the smart multi card and a user terminal is determined, and user authentication information and/or card information is exchanged according to the determined wireless communication method so that security of data transmitted and received between the smart multi card and the user terminal is ensured.

Since user authentication information and/or card information is transmitted and received in an encrypted state between a smart multi card and a user terminal, usage of the smart multi card by another user can be prevented even when a user loses the smart multi card.

Since it is unnecessary to fully input card information of a card to be used for a payment to a user terminal, convenience of a user is improved and it is possible to prevent the card information from being exposed to other people.

### BRIEF DESCRIPTION OF THE DRAWINGS

FIG. 1 is a diagram showing a configuration of a mobile payment system using a smart multi card according to an embodiment of the present invention.

FIG. 2 is a diagram showing a configuration of the user terminal according to an embodiment of the present invention.

FIG. 3 is a diagram showing a configuration of the smart multi card according to an embodiment of the present invention.

FIG. 4 is a diagram showing an example of an appearance of the smart multi card 100 according to an embodiment of the present invention.

FIG. 5 and FIG. 6 is a flowchart illustrating a mobile payment method using the smart multi card according to an embodiment of the present invention.

FIG. 7 and FIG. 8 is a flowchart illustrating a mobile payment method using the smart multi card according to another embodiment of the present invention.

FIG. 9 is a flowchart illustrating step S575 of FIG. 8 in further detail.

### DESCRIPTION OF EXEMPLARY EMBODIMENTS

Preferred embodiments of the present invention will be described below in detail with reference to the accompanying drawings. Advantages and features of the present invention and methods of accomplishing the same should become apparent with reference to embodiments described below in detail in connection with the accompanying drawings. However, the present invention is not limited to the embodiments disclosed below and may be implemented in various different forms. Exemplary embodiments are provided only for completing the disclosure of the present invention and fully representing the scope of the present invention to those skilled in the art. Rather, the scope of the present invention is defined only by the claims. Like reference numerals refer to like elements throughout.

Unless otherwise defined, all terms (including technical and scientific terms) used herein have the same meaning as commonly understood by one of ordinary skill in the art to which this invention belongs. It should be further understood that terms, such as those defined in commonly-used dictionaries, should be interpreted as having meanings that are consistent with their meanings in the context of the relevant art and are not to be interpreted in an idealized or overly formal sense unless expressly so defined herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. The terms “comprises” and/or “comprising” used herein specify the presence of stated elements, but do not preclude the presence or addition of one or more other elements.

Hereinafter, embodiments of the present invention will be described with reference to the appended drawings. In the drawings, like reference numerals refer to like elements.

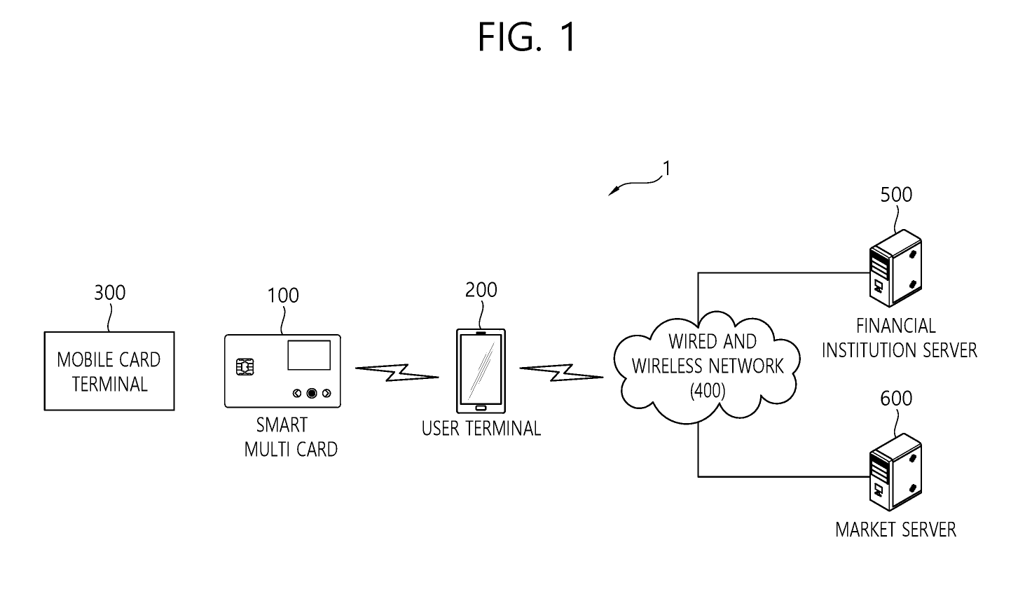

FIG. 1 is a diagram showing a configuration of a mobile payment system 1 using a smart multi card 100 according to an embodiment of the present invention.

Referring to FIG. 1, the mobile payment system 1 using the smart multi card 100 according to an embodiment of the present invention includes a user terminal 200, the smart multi card 100, a financial institution server 500, and a market server 600.

The user terminal 200 stores various kinds of applications. For example, the user terminal 200 stores an ordering application and a card recommendation application. The ordering application refers to an application which enables a user to order a product or food. Ordering applications may exist according to companies, products, kinds of food, or brands. Such ordering applications may be distributed by the market server 600.

The card recommendation application is an application which automatically recommends card information of a card suitable for a payment among pieces of card information of cards stored in the smart multi card 100 when a user tries to make an offline mobile payment or an online mobile payment using the smart multi card 100 that he or she owns. When the user orders a predetermined product or predetermined food through the ordering application or a webpage, the card recommendation application collects order information and automatically recommends a card that is most suitable for a payment on the basis of the collected order information.

The smart multi card 100 stores card information of a plurality of cards. Unlike a conventional financial card including card information of one card in an integrated circuit (IC) chip, the smart multi card 100 includes card information of a plurality of cards in one IC chip. When a card to be used for a payment is recommended by the card recommendation application, the smart multi card 100 loads card information of the recommended card among a plurality of pieces of card information stored in the IC chip. Card information necessary for a payment may be selected by a user or automatically selected on the basis of information on an order made through the user terminal 200.

The financial institution server 500 refers to a server that is administered by a financial institution, such as a bank, a card company, or the like. The financial institution server 500 may issue a smart multi card to a user according to a request of the user. During a process of issuing a smart multi card, at least one of user authentication information, an encryption key, and a decryption key may be set by the user and/or the financial institution server 500 and stored in each of the smart multi card 100 and the financial institution server 500. Here, the user authentication information refers to information that is used for user authentication, and may include at least one of personal information, biometric information, and public certificate information of the user. In addition to this, the financial institution server 500 stores and manages information on the smart multi card 100 issued to the user.

The market server 600 refers to a server administered by a sales company. The market server 600 stores product information of various products. Examples of the product information may be a name, a price, and an expiration date of a product. Also, the market server 600 stores event information of each product. Examples of the event information may be discount information, reward information, and free gift information. Examples of the discount information may be kinds of discount cards, a discount rate, and a discount period. Examples of the reward information may be kinds of reward cards, reward rates, and an accumulation period. The above-described product information and event information may be put on a webpage of the market server 600 or provided through an ordering application for the market server 600. The user may use the user terminal 200 to access the webpage of the market server 600 or execute the ordering application and select and order a desired product from among products listed on the webpage or in the ordering application.

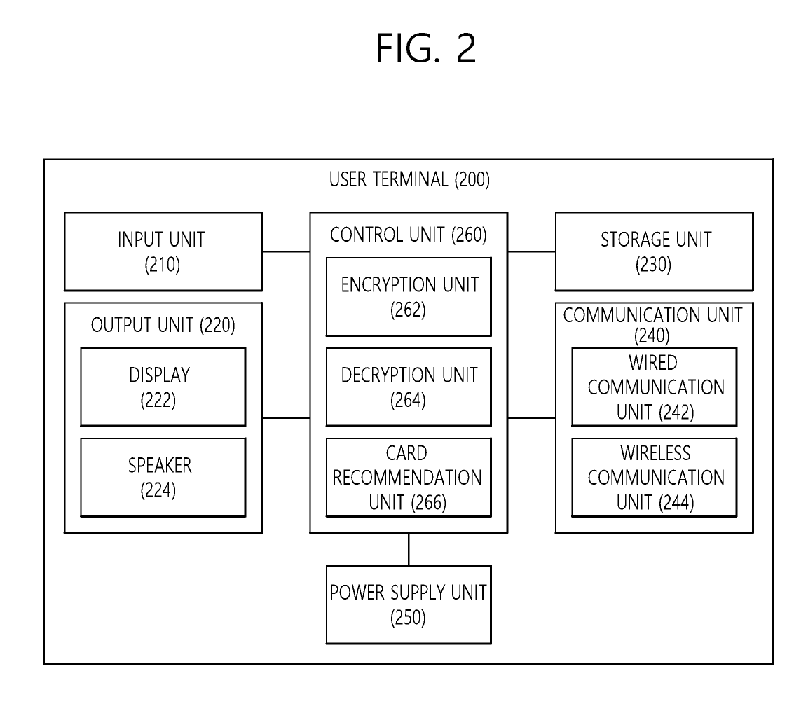

FIG. 2 is a diagram showing a configuration of the user terminal 200 according to an embodiment of the present invention.

Referring to FIG. 2, the user terminal 200 according to an embodiment includes an input unit 210, an output unit 220, a storage unit 230, a communication unit 240, a power supply unit 250, and a control unit 260.

The input unit 210 receives information from a user. For example, user information, card information of the smart multi card 100, and order information for a product order are received. Also, the input unit 210 receives an instruction from a user. For example, an instruction to execute the card recommendation application and an instruction to execute the ordering application are received. However, information or instructions received from a user are not limited to the examples.

To receive information and/or an instruction from a user, the input unit 210 includes an input means such as a keypad, a touchpad, a touch panel, and the like. The touch panel includes a resistive touch panel, a capacitive touch panel, an ultrasonic touch panel, or an infrared touch panel. The touch panel is stacked on a display 222 of the output unit 220, which will be described below, and constitutes a touch screen.

The output unit 220 outputs an instruction processing result as a visual signal and/or an auditory signal. To this end, the output unit 220 includes at least one of the display 222 for outputting the visual signal and a speaker 224 for outputting the auditory signal. The display 222 may be provided as a flat panel display, a flexible display, an opaque display, a transparent display or electronic paper (E-paper), or in any form well known in the art to which the present invention pertains.

The output unit 220 may further include an output means in any form well known in the art to which the present invention pertains in addition to the display 222 and the speaker 224. For example, at least one of an oscillator for outputting a tactile signal, such as vibrations, and a light-emitting device for outputting a light signal may be further included in the output unit 220.

The storage unit 230 may include a non-volatile memory, a volatile memory, an embedded memory, a detachable external memory, a hard disk, an optical disk, a magneto-optical disk, or a computer-readable recording medium in any form well known in the art to which the present invention pertains. Examples of the external memory may be a secure digital (SD) card, a mini SD card, and a micro SD card.

The above-described storage unit 230 stores the ordering application and the card recommendation application. Applications stored in the storage unit 230 are continuously updated. For example a new application is downloaded from the market server 600 or the financial institution server 500 through a wired and wireless network 400, and an application which is stored in the storage unit 230 is replaced with the downloaded new application.

The storage unit 230 stores various kinds of data in addition to the applications. For example, the storage unit 230 stores data received from the financial institution server 500, data collected by the card recommendation application, data received from the market server 600, data received from the smart multi card 100, or a combination thereof.

Examples of the data received from the financial institution server 500 may be user authentication information, an encryption key, a decryption key, or a combination thereof. The user authentication information may include at least one of personal information, biometric information, and public certificate information of a user. The encryption key refers to a key which is used to encrypt data to be transmitted from the user terminal 200 to the smart multi card 100, and the decryption key refers to a key which is used to decrypt data encrypted in the smart multi card 100 and transmitted to the user terminal 200. The user authentication information, the encryption key, the decryption key, or a combination thereof may be downloaded from the financial institution server 500 through the wired and wireless network 400 when an authentication operation for the user terminal 200 is completed in the financial institution server 500.

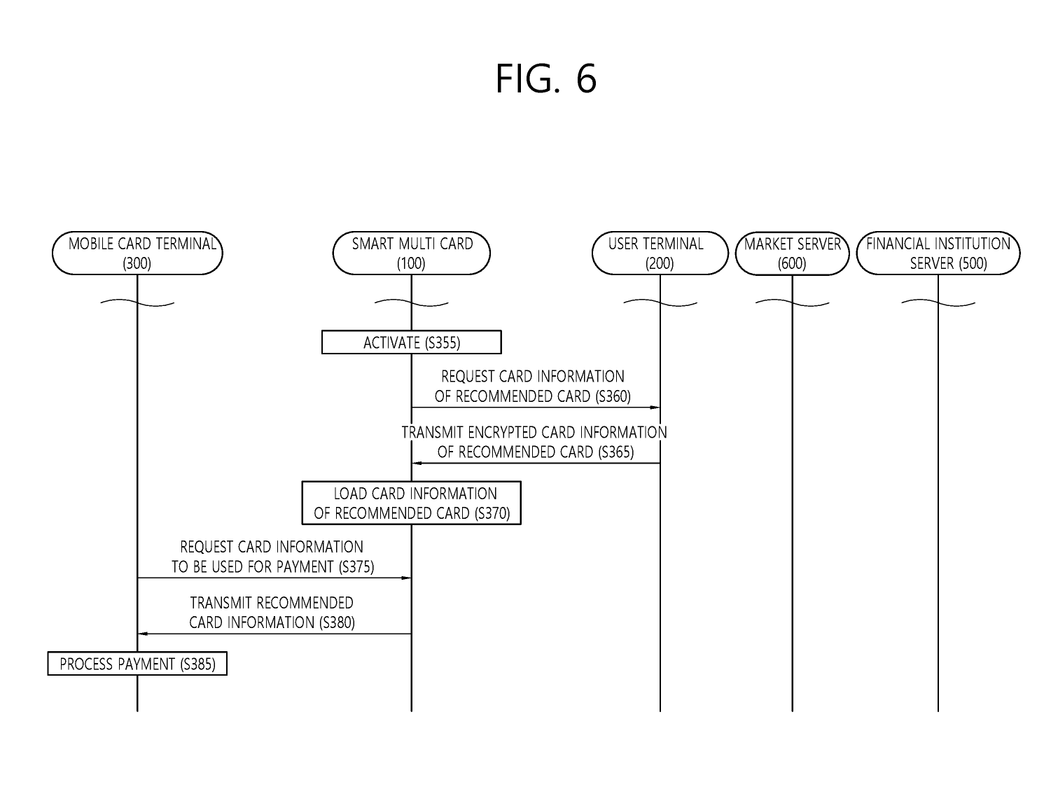

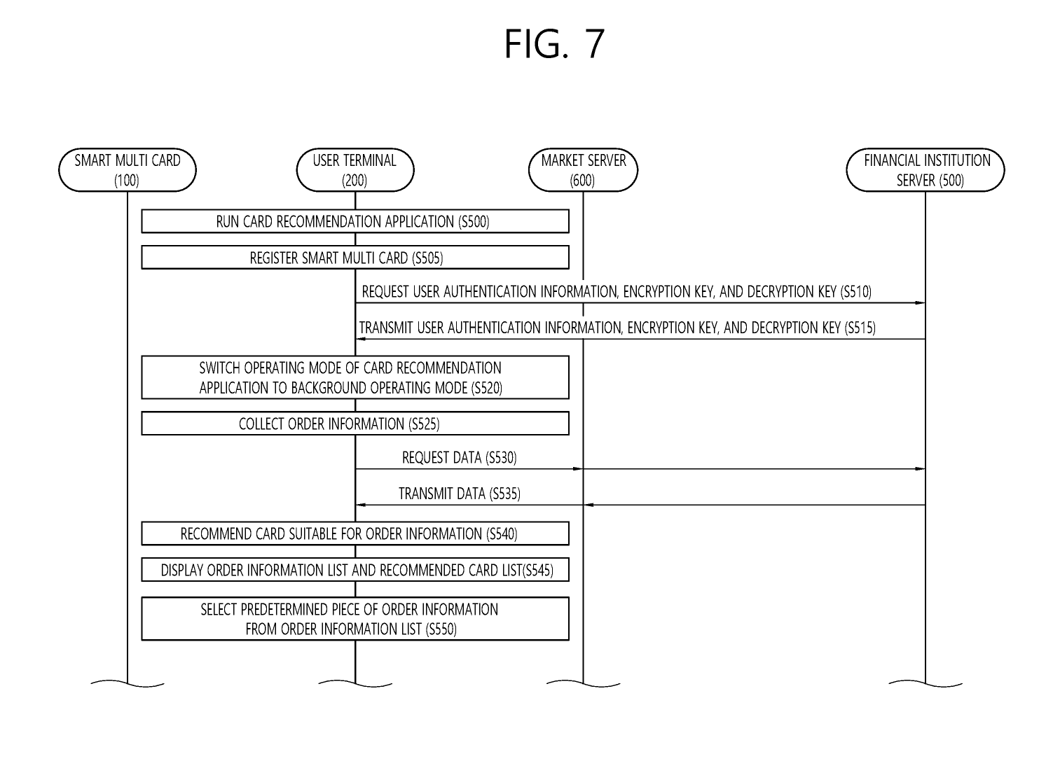

The user authentication information stored in the storage unit 230 of the user terminal 200 may be used as data for user authentication when an online mobile payment is made with the smart multi card 100. Specifically, mobile payments include an offline mobile payment and an online mobile payment. The offline mobile payment refers to a payment made on the basis of communication between the smart multi card 100 and a mobile card terminal (a point of sales (POS) terminal) 300. The online mobile payment refers to a payment made on the basis of communication between the smart multi card 100 and the user terminal 200. Use of user authentication information will be described in detail below with reference to FIGS. 6 and 7.

Examples of the data collected by the card recommendation application may be order information. The order information is information generated when a user orders a predetermined product through the webpage of the market server 600 or the ordering application. Examples of the order information may be a product name, a product price, a store, and a phone number of the store, but the order information is not necessarily limited to the examples.

Examples of the data received from the market server 600 may be event information related to the order information. Example of the event information may be discount information, reward information, free gift information, or a combination thereof.

Examples of the data received from the smart multi card 100 may be encrypted user authentication information and encrypted recommended card information. The smart multi card 100 may use the encryption key stored therein to encrypt user authentication information or recommended card information. This will be described in further detail below with reference to FIGS. 6 and 7.

The communication unit 240 communicates with at least one of the financial institution server 500, the market server 600, and the smart multi card 100 through the wired and wireless network 400. The communication unit 240 includes a wired communication unit 242 and a wireless communication unit 244. The wireless communication unit 244 supports at least one wireless communication method. Examples of the wireless communication method may be wireless broadband Internet (WiBro), wireless fidelity (WiFi), ZigBee, ultra wideband (UWB), Bluetooth, Bluetooth low energy (BLE), and near field communication (NFC).

The power supply unit 250 supplies power to each component of the user terminal 200. The power supply unit 250 is recharged in various ways. In an example, the power supply unit 250 is recharged by being supplied with power from a general power source (not shown) through a cable connected to the general power source. In another example, the power supply unit 250 is recharged by being supplied with power from a wireless charging device (not shown) electrically connected to a general power source according to wireless power transmission technology.

The control unit 260 connects components in the user terminal 200 to each other and controls the components. Specifically, when an instruction to execute the card recommendation application is input, the control unit 260 runs the card recommendation application stored in the storage unit 230. Subsequently, when card information of the smart multi card 100 carried by a user is registered, the control unit 260 requests data from the financial institution server 500. For example, at least one of user authentication information, an encryption key, and a decryption key is requested.

Meanwhile, the control unit 260 may further include at least one of an encryption unit 262, a decryption unit 264, and a card recommendation unit 266.

The encryption unit 262 of the control unit 260 stores the user authentication information, the encryption key, and the decryption key received from the financial institution server 500.

When encrypted data is received from the smart multi card 100, the decryption unit 264 of the control unit 260 uses the decryption key to decrypt the encrypted data.

When a product order is made through the user terminal 200, the card recommendation unit 266 of the control unit 260 collects order information. In an example, the order information may include data which is input by a user during a process of ordering a product through the ordering application or a webpage. In another example, the order information may include a short message of a detailed order which is received by the user terminal 200 after the product order is completed. The short message of the detailed order may be transmitted by the market server 600.

When the order information is collected in this way, the card recommendation unit 266 requests data related to the order information from each of the market server 600 and the financial institution server 500. Specifically, the card recommendation unit 266 requests event information related to the order information from the market server 600 and requests card application status information of the smart multi card 100 from the financial institution server 500.

When the event information and the card application status information are respectively received from the market server 600 and the financial institution server 500, the card recommendation unit 266 analyzes the received event information, the received card application status information, and previously stored card information of the smart multi card 100. Then, the card recommendation unit 266 selects a card which is most suitable for the order information as a recommended card from among a plurality of cards included in the smart multi card 100 on the basis of the analysis results.

For example, it is assumed that the smart multi card 100 includes card information of a first card and card information of a second card. Also, the event information is assumed to indicate that a discount rate increases in order of the first card, the second card, a third card, and so on. In this case, the card recommendation unit 266 may select the second card as the recommended card.

When the event information indicates that a discount is available with only the third card and a fourth card, the card recommendation unit 266 compares application status information of the first card and application status information of the second card. Then, the card recommendation unit 266 selects a card which has higher application status between the first card and the second card. When a discount rate of the first card is the same as a discount rate of the second card, the card recommendation unit 266 selects a card which has high weekly application status, high monthly card application status, or high annual card application status as the recommended card. In this way, when a card having high application status is selected first, the overall application status of the card can be improved, and consequently benefits of the user can be extended.

Meanwhile, when the user orders several products, several pieces of order information are collected. In this case, the card recommendation unit 266 collects and analyzes event information and card application status information in relation to each of the pieces of order information and selects a recommended card suitable for each of the pieces of order information. An order information list and/or a recommended card list generated in this way may be displayed through the display 222 of the output unit 220.

When any one of the pieces of order information is selected from the order information list displayed in the display 222, the encryption unit 262 encrypts card information of a recommended card corresponding to the selected piece of order information and transmits the encrypted card information to the smart multi card 100. Specifically, examples of the card information may be a card company, a card security code, a card verification code, and a card verification value. The encryption unit 262 may encrypt only the card company and the card security code, or encrypt all of the card information.

The user terminal 200 according to an embodiment of the present invention has been described above with reference to FIG. 2. The above-described user terminal 200 may be a wired and wireless communication device which is personally owned by the user. Examples of the wired and wireless communication device may be a personal computer (PC), a cellular phone, a personal communication service (PCS) phone, a synchronous/asynchronous international mobile telecommunication-2000 (IMT-2000) mobile terminal, a palm PC, a personal digital assistant (PDA), a smart phone, a wireless application protocol (WAP) phone, a mobile game machine, and a tablet PC.

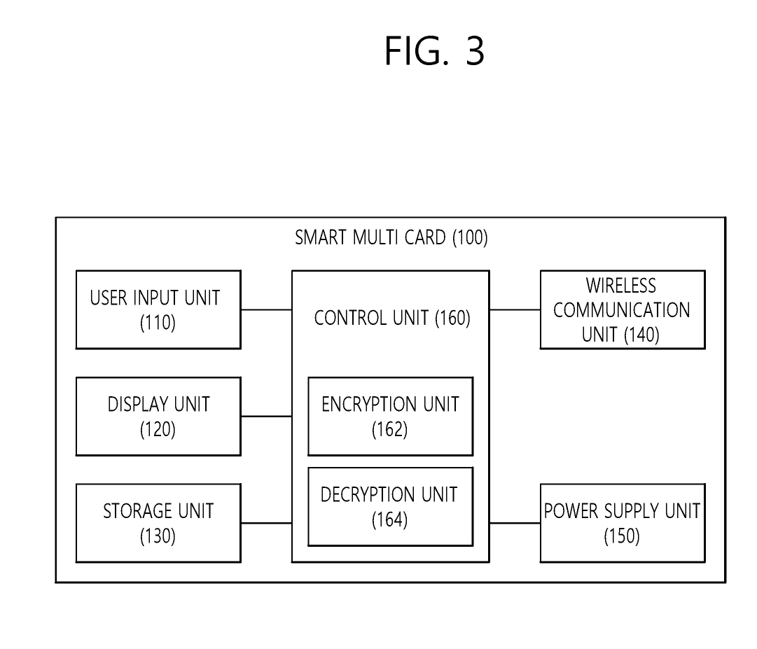

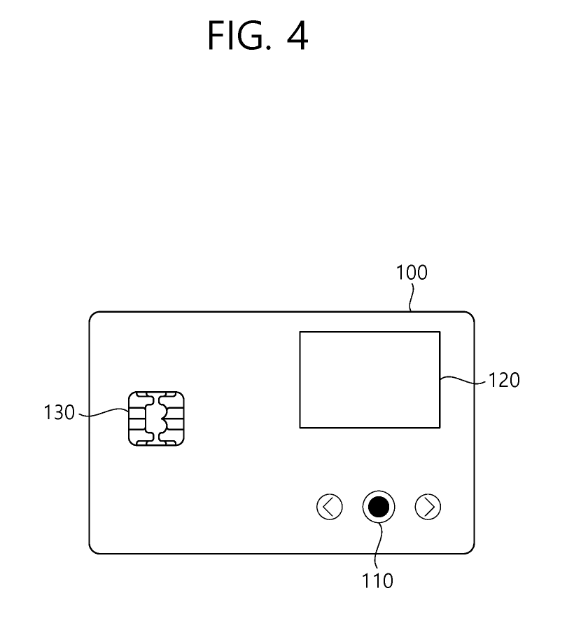

FIG. 3 is a diagram showing a configuration of the smart multi card 100 according to an embodiment of the present invention. FIG. 4 is a diagram showing an example of an appearance of the smart multi card 100 according to an embodiment of the present invention.

Referring to FIGS. 3 and 4, the smart multi card 100 according to an embodiment includes a user input unit 110, a display unit 120, a storage unit 130, a wireless communication unit 140, a power supply unit 150, and a control unit 160.

The user input unit 110 receives an instruction from a user. To this end, the user input unit 110 may include at least one button. Referring to FIG. 4, it can be seen that the user input unit 110 includes three buttons (e.g., two directional buttons and one selection button). Although not shown in the drawing, the at least one button may be replaced with at least one of a keypad, a keyboard, a touchpad, and a dome switch. The touchpad may be stacked on the display unit 120, which will be described below, and constitute a touch screen. When a touch screen is implemented in this way, a keypad or a keyboard may be implemented in a software manner and displayed through the touch screen.

The display unit 120 displays information processed in the smart multi card 100. For example, when the smart multi card 100 is in a payment mode, the display unit 120 displays card information of a card to be used for a payment. When the smart multi card 100 is in a reward mode, the display unit 120 displays a barcode of a card to be rewarded. The display unit 120 may display a graphical user interface related to the smart multi card 100 in addition to the card information.

As described above, a touch pad may be stacked on the display unit 120 and constitute a touch screen. In this case, the display unit 120 is considered to have both an output function and an input function.

The storage unit 130 stores data required for the smart multi card 100 to operate. For example, the storage unit 130 separately stores pieces of card information of several cards. Here, examples of the card information may be card companies, card security codes, card verification codes, and card verification values. The card information of several cards is stored in the storage unit 130 during a process in which a user is issued with the smart multi card 100 by a financial institute.

The storage unit 130 stores at least one of user authentication information, an encryption key, and a decryption key in addition to the data. The user authentication information, the encryption key, and the decryption key is stored in the storage unit 130 during a process in which a user is issued with the smart multi card 100 by a financial institute.

The above-described storage unit 130 may be implemented as an IC chip. In the IC chip, a micro processor unit (MPU) having a calculation function may be provided. A part of the IC chip is exposed to the outside of the smart multi card 100 as shown in FIG. 4. The exposed part may physically come into contact with a fixed card terminal (not shown) or the mobile card terminal 300, and a payment may proceed through the physically contacted part.

The wireless communication unit 140 may communicate with the user terminal 200. The wireless communication unit 140 may support at least one wireless communication method. Examples of the wireless communication method may be WiBro, WiFi, ZigBee, UWB, Bluetooth, BLE, and NFC, but the wireless communication method is not limited to the examples.

The power supply unit 150 supplies power to each component in the smart multi card 100. The power supply unit 150 may include a battery. The battery may be recharged by being supplied with power from a wireless charging device (not shown) electrically connected to a used power source according to wireless power transmission technology. In another example, the battery may be physically separated from the smart multi card 100, and the separated battery may be replaced with a new battery.

The control unit 160 connects the components in the smart multi card 100 to each other and controls the components. For example, the control unit 160 determines a kind of instruction input through the user input unit 110 and performs an operation corresponding to the input instruction. Specifically, the control unit 160 causes power to be supplied to each component when a power supply instruction is input through the user input unit 110, and stops the supply of power to each of the components when a power supply interruption instruction is input. When an activation instruction is input through the user input unit 110, the control unit 160 activates a specific component, for example, the wireless communication unit 140. Conversely, when a deactivation instruction is input through the user input unit 110, the control unit 160 deactivates an activated component. In the above description, the power supply instruction and the activation instruction are separate from each other, but the power supply instruction and the activation instruction may be integrated into one instruction. In other words, when the power supply instruction is input, each component may be supplied with power and also activated.

Meanwhile, the control unit 160 may further include at least one of an encryption unit 162 and a decryption unit 164. The encryption unit 162 uses the previously stored encryption key to encrypt data to be transmitted to the user terminal 200. When encrypted data is received from the user terminal 200, the decryption unit 164 uses the previously stored decryption key to decrypt the encrypted data.

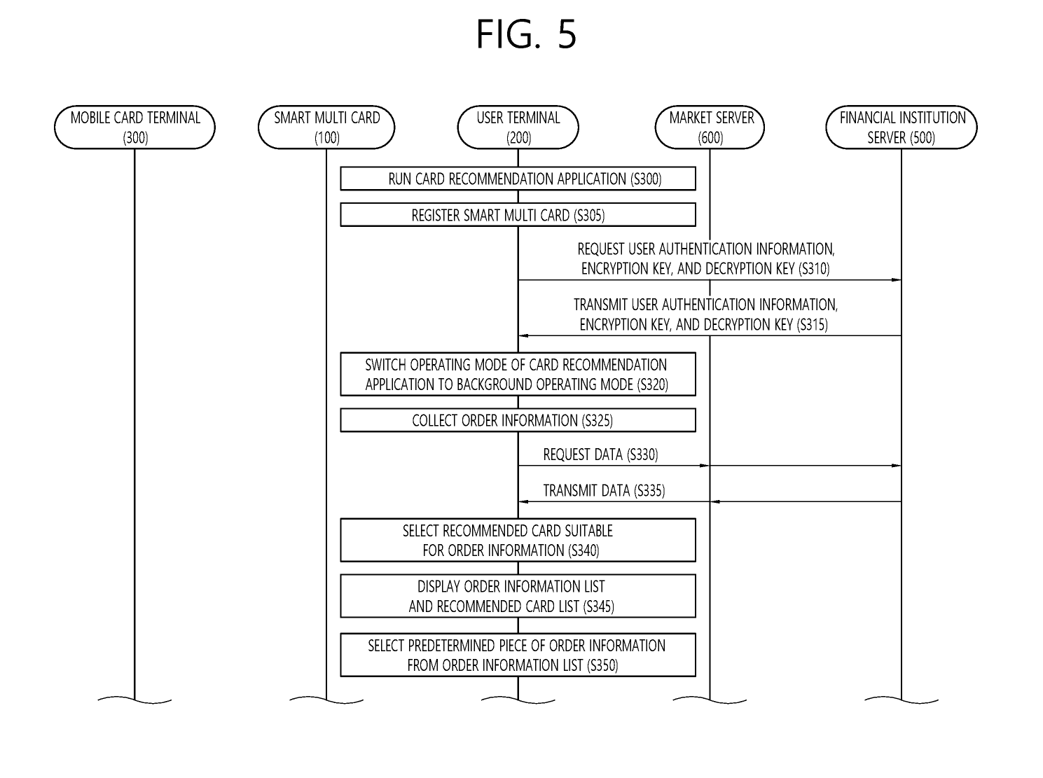

FIG. 5 and FIG. 6 is a flowchart illustrating a mobile payment method using the smart multi card 100 according to an embodiment of the present invention. Specifically, FIG. 5 and FIG. 6 is a flowchart illustrating an offline mobile payment method performed between the smart multi card 100 and the mobile card terminal 300.

Before the description, it is assumed that a user is issued with the smart multi card 100 through a financial institution. Also, when the smart multi card 100 is issued, at least one of user authentication information, an encryption key, and a decryption key may be designated, and it is assumed that the designated user authentication information, encryption key, and decryption key are stored in each of the financial institution server 500 and the smart multi card 100. Further, it is assumed that the card recommendation application and the ordering application are installed in the user terminal 200.

In this situation, when an instruction to execute the card recommendation application is input, the user terminal 200 runs the card recommendation application (S300).

Subsequently, when card information of the smart multi card 100 is registered (S305), the user terminal 200 requests data from the financial institution server 500 on the basis of the card information (S310). For example, at least one of the user authentication information, the encryption key, and the decryption key is requested from the financial institution server 500.

When the data is received from the financial institution server 500 (S315), the user terminal 200 stores the received data in the storage unit 230 and switches the operating card recommendation application from an operating mode to a background operating mode (S320).

Subsequently, when the user orders a predetermined product through the ordering application, a webpage, or the like, the user terminal 200 collects order information (S325). Here, the order information may include data that is input by the user during a process of ordering the product through the ordering application or the webpage. In another example, the order information may include a short message of a detailed order which is received by the user terminal 200 after the product order is made.

Subsequently, the user terminal 200 requests data related to the collected order information from each of the financial institution server 500 and the market server 600 (S330). For example, the user terminal 200 requests event information related to the order information from the market server 600 and requests card application status information of cards included in the smart multi card 100 from the financial institution server 500.

The market server 600 and the financial institution server 500 respectively transmit the event information and the card application status information to the user terminal 200 (S335).

Subsequently, the user terminal 200 analyzes at least one of the event information received from the market server 600, the card application status information received from the financial institution server 500, and previously registered card information of the smart multi card 100. Then, the user terminal 200 selects a card which is most suitable for the order information as a recommended card from among the plurality of cards included in the smart multi card 100 on the basis of the analysis results (S340). According to an embodiment, step S340 may include a step of selecting a card having the highest discount rate as the recommended card from among the plurality of cards included in the smart multi card 100 and a step of selecting a card having high application status as the recommended card when there is no discount card among the plurality of cards included in the smart multi card 100 or several cards have the same discount rate.

Meanwhile, when several pieces of order information are collected in step S325, a recommended card is selected for each of the pieces of order information. An order information list and a recommended card list which are acquired in this way are displayed through the display 222 of the user terminal 200 (S345). The user can select a predetermined piece of order information from the displayed order information list (S350).

Meanwhile, the smart multi card 100 is activated according to an instruction input through the user input unit 110 (S355) and then requests card information of the recommended card from the user terminal 200 (S360). As a result, the user terminal 200 uses the encryption key to encrypt the card information of the recommended card corresponding to the piece of order information previously selected in step S350 and then transmits the encrypted card information of the recommended card to the smart multi card 100 (S365).

The smart multi card 100 uses the decryption key to decrypt the encrypted card information of the recommended card and then loads the decrypted card information of the recommended card (S370).

In this situation, when the mobile card terminal 300 and the smart multi card 100 come into contact with each other, the mobile card terminal 300 requests card information to be used for a payment from the smart multi card 100 (S375). As a result, the smart multi card 100 transmits the loaded card information to the mobile card terminal 300 (S380).

Subsequently, the mobile card terminal 300 processes the payment on the basis of the received card information of the recommended card (S385). Specifically, the mobile card terminal 300 transmits a payment request signal to the financial institution server 500 and receives a payment processing result from the financial institution server 500.

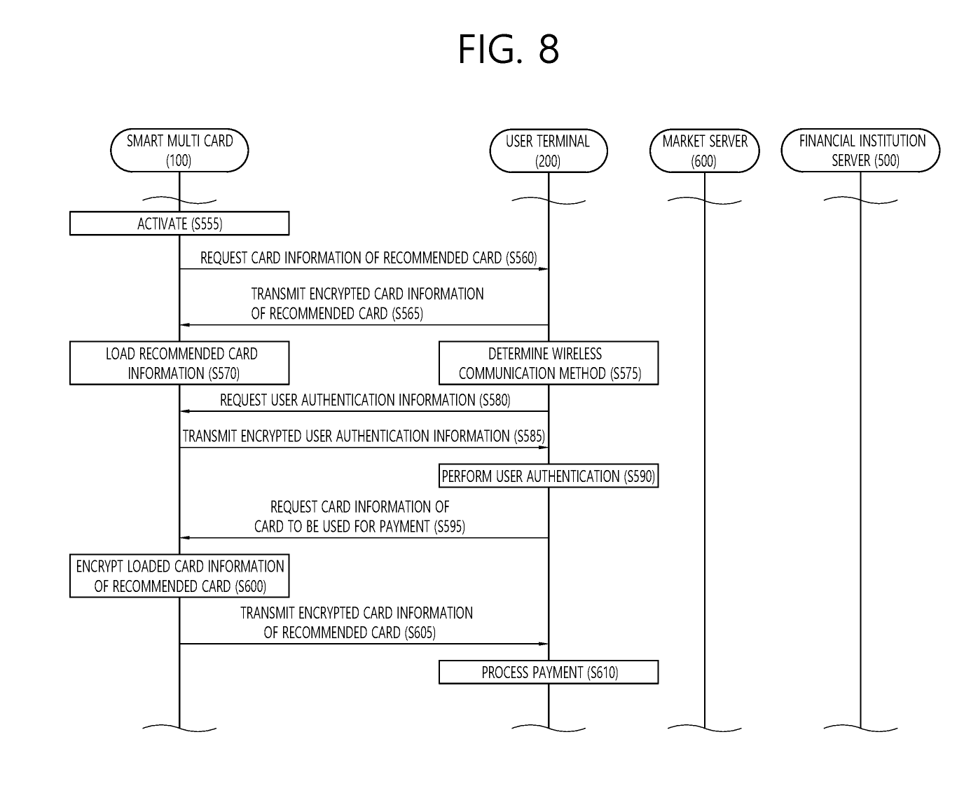

FIG. 7 and FIG. 8 is a flowchart illustrating a mobile payment method using the smart multi card 100 according to another embodiment of the present invention. Specifically, FIG. 6 is a flowchart illustrating an online mobile payment method performed between the smart multi card 100 and the user terminal 200.

Before the description, it is assumed that a user is issued with the smart multi card 100 through a financial institution. Also, when the smart multi card 100 is issued, at least one of user authentication information, an encryption key, and a decryption key may be designated, and it is assumed that the designated user authentication information, encryption key, and decryption key are stored in each of the financial institution server 500 and the smart multi card 100. Further, it is assumed that the card recommendation application and the ordering application are installed in the user terminal 200.

In this situation, when an instruction to execute the card recommendation application is input, the user terminal 200 runs the card recommendation application (S500).

Subsequently, when card information of the smart multi card 100 is registered (S505), the user terminal 200 requests data from the financial institution server 500 on the basis of the card information (S510). For example, at least one of the user authentication information, the encryption key, and the decryption key is requested from the financial institution server 500.

When the data is received from the financial institution server 500, the user terminal 200 stores the received data in the storage unit 230 and switches the operating card recommendation application from an operating mode to the background operating mode (S520).

Subsequently, when the user orders a predetermined product through the ordering application, a webpage, or the like, the user terminal 200 collects order information (S525). Here, the order information may include data that is input by the user during a process of ordering the product through the ordering application or the webpage. In another example, the order information may include a short message of a detailed order which is received by the user terminal 200 after the product order is made.

Subsequently, the user terminal 200 requests data related to the collected order information from each of the financial institution server 500 and the market server 600 (S530). For example, the user terminal 200 requests event information related to the order information from the market server 600 and requests card application status information of cards included in the smart multi card 100 from the financial institution server 500.

The market server 600 and the financial institution server 500 respectively transmit the event information and the card application status information to the user terminal 200 (S535).

Subsequently, the user terminal 200 analyzes at least one of the event information received from the market server 600, the card application status information received from the financial institution server 500, and previously registered card information of the smart multi card 100. Then, the user terminal 200 selects a card which is most suitable for the order information as a recommended card from among the plurality of cards included in the smart multi card 100 on the basis of the analysis results (S540). According to an embodiment, step S540 may include a step of selecting a card having the highest discount rate as the recommended card from among the plurality of cards included in the smart multi card 100 and a step of selecting a card having high application status as the recommended card when there is no discount card among the plurality of cards included in the smart multi card 100 or several cards have the same discount rate.

Meanwhile, when several pieces of order information are collected in step S525, a recommended card is selected for each of the pieces of order information. An order information list and a recommended card list which are acquired in this way are displayed through the display 222 of the user terminal 200 (S545). The user can select a predetermined piece of order information from the displayed order information list (S550).

Meanwhile, the smart multi card 100 is activated according to an instruction input through the user input unit 110 (S555) and then requests card information of the recommended card from the user terminal 200 (S560). As a result, the user terminal 200 uses the encryption key to encrypt the card information of the recommended card corresponding to the piece of order information previously selected in step S550 and then transmits the encrypted card information of the recommended card to the smart multi card 100 (S565).

The smart multi card 100 uses the decryption key to decrypt the encrypted card information of the recommended card and then loads the decrypted card information of the recommended card (S570).

Subsequently, the user terminal 200 determines a wireless communication method for communication with the smart multi card 100 (S575). Step S575 will be described in more detail below with reference to FIG. 7.

When the wireless communication method for communication with the smart multi card 100 is determined, the user terminal 200 requests user authentication information from the smart multi card 100 (S580). Then, the smart multi card 100 uses the previously stored encryption key to encrypt the previously stored user authentication information, and transmits the encrypted user authentication information to the user terminal 200 (S585).

The user terminal 200 performs user authentication on the basis of the encrypted user authentication information received from the smart multi card 100 and previously stored user authentication information (S590). Step S590 may include a step of using a previously stored decryption key to decrypt the encrypted user authentication information, a step of determining that the user authentication has failed when the decryption fails or the decrypted user authentication information does not coincide with the previously stored user authentication information, and a step of determining that the user authentication has succeeded when the decrypted user authentication information coincides with the previously stored user authentication information.

When the user authentication has succeeded, the user terminal 200 requests card information of a card to be used for a payment from the smart multi card 100 (S595). Then, the smart multi card 100 uses the previously stored encryption key to encrypt the loaded card information of the recommended card (S600) and transmits the encrypted card information of the recommended card to the user terminal 200 (S605).

Subsequently, the user terminal 200 processes the payment on the basis of the encrypted and received card information of the recommended card (S610). Specifically, the user terminal 200 uses the previously stored decryption key to decrypt the encrypted card information of the recommended card, generates a payment request signal on the basis of the decrypted card information of the recommended card, and then transmits the generated payment request signal to the financial institution server 500. Then, the user terminal 200 receives a payment processing result from the financial institution server 500.

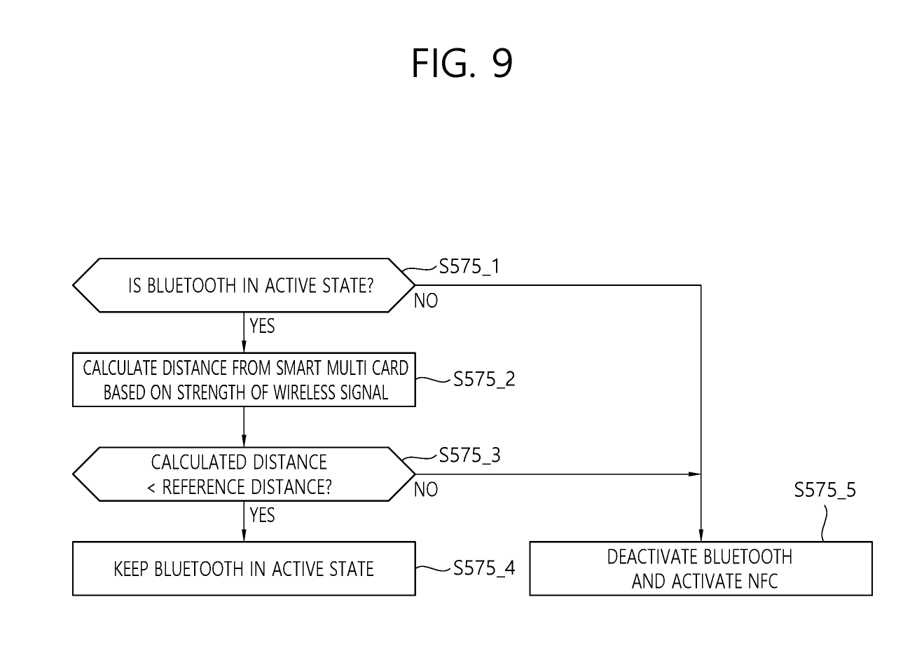

FIG. 9 is a flowchart illustrating step S575 of FIG. 8 in further detail.

First, the user terminal 200 determines whether Bluetooth among wireless communication methods of the user terminal 200 is in an active state (S575_1).

When Bluetooth is determined to be in the active state in step S575_1, the user terminal 200 calculates a distance from the smart multi card 100 on the basis of a strength of a wireless signal received from the smart multi card 100 (S575_2).

Subsequently, the user terminal 200 determines whether the calculated distance is less than or equal to a reference distance (S575_3). The reference distance may be set to a value of 1 cm to 10 cm. For example, the reference distance may be set to 5 cm. The set reference distance value may be changed by the user. Specifically, the card recommendation application may include a menu for setting the reference distance, and the user may set the reference distance value or change a preset reference distance value through the menu.

Meanwhile, when the distance between the smart multi card 100 and the user terminal 200 is determined to be less than or equal to the reference distance in step S575_3, the user terminal 200 keeps Bluetooth in the active state (S575_4). As a result, data is transmitted and received between the user terminal 200 and the smart multi card 100 in a Bluetooth manner.

When the distance between the smart multi card 100 and the user terminal 200 is determined to be greater than the reference distance in step S575_3, the user terminal 200 deactivates Bluetooth and activates NFC (S575_5). As a result, data is transmitted and received between the user terminal 200 and the smart multi card 100 in an NFC manner.

Embodiments of the present invention have been described above. In addition to the above-described embodiments, embodiments of the present invention may be implemented through a medium including a computer-readable code/instruction for controlling at least one component of the above-described embodiments. The medium may correspond to a medium/media that enable storage and/or transmission of the computer-readable code.

The computer-readable code may be recorded in media and also transmitted through the Internet, and the media may include, for example, recording media, such as magnetic storage media (e.g., a read-only memory (ROM), a floppy disk, a hard disk, etc.), optical recording media (e.g., a compact disk ROM (CD-ROM), Blu-ray, and digital versatile disk (DVD)), and transmission media, such as a carrier wave. Since the media may be distributed in networks, the computer-readable code can be stored/transmitted and executed in a distributed fashion. Furthermore, as just one example, a processing element may include a processor or a computer processor, and may be distributed and/or included in a single device.

Embodiments of the present invention have been described above with reference to the accompanying drawings. Those skilled in the art should understand that various changes in form and details may be made therein without departing from the spirit and scope of the invention as defined by the appended claims. The above embodiments are accordingly to be regarded as illustrative rather than restrictive.

1-10. (canceled)

11. A mobile payment method using a smart multi card, the method comprising:
storing card information of a smart multi card;
collecting order information of a product ordered through a user terminal;
selecting a recommended card suitable for the order information from among a plurality of cards included in the smart multi card; and
transmitting card information of the recommended card to the smart multi card.

12. The mobile payment method according to claim 11, wherein the selecting of the recommended card comprises:
receiving event information related to the order information from a market server;
receiving card application status information of the smart multi card from a financial institution server;
selecting the recommended card based on at least one of a discount rate and a reward rate acquired from the event information; and
when a plurality of recommended cards are selected based on the at least one of the discount rate and the reward rate, selecting one of the plurality of recommended cards based on the card application status information.

13. The mobile payment method according to claim 11, wherein the selecting of the recommended card comprises, when several pieces of order information are collected, selecting a recommended card for each of the pieces of order information.

14. The mobile payment method according to claim 13, further comprising:
displaying an order information list including the several pieces of order information; and
when a predetermined piece of order information is selected from the order information list, transmitting card information of a recommended card corresponding to the selected piece of order information to the smart multi card.

15. The mobile payment method according to claim 14, wherein the card information of the recommended card corresponding to the selected piece of order information is encrypted using a previously stored encryption key and then transmitted to the smart multi card, and
the encryption key is received from a financial institution server which has issued the smart multi card.

16. The mobile payment method according to claim 11, further comprising:
determining a wireless communication method for data transmission and reception with the smart multi card;
receiving encrypted user authentication information from the smart multi card;
performing user authentication based on the encrypted user authentication information and previously stored user authentication information;
when the user authentication succeeds, requesting card information of a card to be used for a payment from the smart multi card;
receiving encrypted card information of the recommended card from the smart multi card; and
processing the payment based on the encrypted card information of the recommended card.

17. The mobile payment method according to claim 16, wherein the determining of the wireless communication method comprises:
when a first wireless communication method is in an active state, calculating a distance from the smart multi card based on a strength of a wireless signal received from the smart multi card;
when the calculated distance is less than or equal to a reference distance, keeping the first wireless communication method in the active state; and
when the calculated distance is greater than the reference distance, deactivating the first wireless communication method and activating a second wireless communication method.

18. The mobile payment method according to claim 16, wherein the performing of the user authentication comprises:
decrypting the encrypted user authentication information using a previously stored decryption key;
when the decrypted user authentication information coincides with the previously stored user authentication information, determining that the user authentication has succeeded; and
when the decryption fails or the decrypted user authentication information does not coincide with the previously stored user authentication information, determining that the user authentication has failed, and
the decryption key is received from a financial institution server.

19. The mobile payment method according to claim 16, wherein the recommended card information is loaded onto the smart multi card.

20. A computer program for executing the mobile payment method using a smart multi card according to claim 11.
